(19) United States
(12) Patent Application Publication
(10) Pub. No.: US 2013/0275618 A1
(43) Pub. Date: Oct. 17, 2013

(54) METHOD AND APPARATUS FOR REDUCING CONTENT REDUNDANCY IN CONTENT-CENTRIC NETWORKING

(71) Applicants: Krishna P. Puttaswamy Naga, Metuchen, NJ (US); Matteo Varvello, Port Monmouth, NJ (US); Diego Perino, Issy-les-Moulineaux (FR)

(72) Inventors: Krishna P. Puttaswamy Naga, Metuchen, NJ (US); Matteo Varvello, Port Monmouth, NJ (US); Diego Perino, Issy-les-Moulineaux (FR)

(73) Assignees: ALCATEL-LUCENT BELL LABS FRANCE, Route de Villejust, Nozay (FR); ALCATEL-LUCENT USA INC., Murray Hill, NJ (US)

(21) Appl. No.: 13/448,661

(22) Filed: Apr. 17, 2012

(51) Int. Cl. G06F 15/16

(52) U.S. Cl. 709/236

(57) ABSTRACT

A method for reducing content redundancy in CCN includes distributing named media content or another type of content from sources to consumers through host devices and intermediate devices via a communication network using object messages that carry fingerprint names and data chunks. The named content is divisible into data chunks represented by fingerprint names such that a content fingerprint list for content identifies data chunks for the content using fingerprint names. The fingerprint names are based on content data in the data chunk such that data chunks with the same content data for the named content and for other content are represented by the same fingerprint name and data chunks with different content data are represented by different fingerprint names. A subsystem associated with the method includes consumer and source communication modules; a local storage device; message routing, fingerprint list processing, and object caching modules; and a message processing controller.

### BACKGROUND

This disclosure relates to improvements to a content-centric networking (CCN) approach to a network architecture and supporting communication protocols that reduce content redundancy in conjunction with caching of data in network elements between a host source of media content or other types of content and a originating consumer device desiring the corresponding content. Various embodiments of a system, CCN message processing subsystem, and methods disclosed herein provide various combinations of features to reduce content redundancy in CCN. For example, the processes discloses herein cache data in portions of content and identify the portions based at least in part on data content rather than document names. Additionally, supporting messages and message exchanges between network elements involved in transporting the content are provided herein.

In recent years, several networking researchers have attempted a clean-slate redesign of the Internet to meet the needs of today's applications that rely heavily on content distribution. One widely accepted outcome of this effort is a networking paradigm called content-centric networking (CCN) which is also referred to as named data networking (NDN) and information-centric networking (ICN). For additional information on CCN, see Perino et al., A Reality Check for Content Centric Networking, Proceedings of the ACM SIGCOMM Workshop on Information-Centric Networking (ICN) 2011, Aug. 15-19, 2011, pp. 44-49 and Jacobson et al., Networking Named Content, Proceedings of Conference on Emerging Networking Experiments and Technologies (CoNEXT), Dec. 1-4, 2009, Rome, Italy, Vol. 178, Issue 1, pp. 1-12. For additional information on NDN, see Zhang et al., Named Data Networking (NDN) Project, PARC Technical Report NDN-0001, Oct. 31, 2010, 26 pages. For additional information on ICN, see Kutscher et al., 10492 Abstracts Collection—Information-Centric Networking, Proceedings of Dagstuhl Seminar 10492 on Information-Centric Networking, Dagstuhl, Germany, Dec. 5-8, 2010, 17 pages. The contents of each of these documents are fully incorporated herein by reference.

CCN includes wide-spread caching of data in network elements (including routers) to offer benefits such as reduced data access latency, reduced load on the network, and lower energy costs. However, in the current design of CCN, data from each source is cached using a key specific to each chunk from that source. This leads to caching of a significant amount of duplicate content because content that is common in different documents from the same source is cached multiple times as they map to different keys. This duplication can severely hurt CCN's efficiency due to its widespread caching feature.

Currently, in CCN, content is cached based on names: two content items with the same name are considered equal and thus only one copy is stored. For example, consider two documents with names “<backslash> lucent <dot> com <backslash> page1 <dot> html” and “<backslash> lucent <dot> com <backslash> page2 <dot> html”, respectively; let's say that each of these two documents is 2,000 bytes long and that the last 1,000 bytes of the two pages are the same—say some copyright information of lucent <dot> com. In CCN, each router routing these documents will cache the last 1,000 bytes of both documents, although only one copy should be sufficient. This happens because the caching works solely based on content names and is unaware that some bytes are common across the two documents.

Based on the foregoing, it is desirable to improve current approaches to CCN by reducing content redundancy in conjunction with caching of data in network elements between a host source and an originating consumer device that desires content. Moreover, it is desirable to control caching of data under CCN based on data content rather than content names.

### SUMMARY

In one aspect, a method for reducing content redundancy in content-centric networking (CCN) is provided. In one embodiment, the method includes: distributing named content from content sources to content consumers through any combination of host source devices and intermediate source devices via a communication network using object messages that carry corresponding fingerprint names and data chunks. The named content is divisible into data chunks that are represented by corresponding fingerprint names such that a content fingerprint list for chosen content identifies the data chunks for the chosen content using the corresponding fingerprint names. The fingerprint names are based on content data in the corresponding data chunk such that data chunks with the same content data for the same chosen content and for other named content are represented by the same fingerprint name and data chunks with different content data are represented by different fingerprint names.

In another aspect, a system for reducing content redundancy in CCN is provided. In one embodiment, the system includes: host source devices, intermediate source devices, and a communication network. Each intermediate source device including a local storage device. The system is configured to distribute named content from content sources to content consumers through any combination of host source devices and intermediate source devices via the communication network using object messages that carry corresponding fingerprint names and data chunks. The named content is divisible into data chunks that are represented by corresponding fingerprint names such that a content fingerprint list for chosen content identifies the data chunks for the chosen content using the corresponding fingerprint names. The fingerprint names are based on content data in the corresponding data chunk such that data chunks with the same content data for the same chosen content and for other named content are represented by the same fingerprint name and data chunks with different content data are represented by different fingerprint names.

In yet another aspect, an apparatus for reducing content redundancy in CCN is provided. In one embodiment, the apparatus includes: a consumer communication module, a source communication module, a local storage device, a message routing module, a fingerprint list processing module, an object caching module, and a message processing controller. The consumer communication module configured to receive content object interest messages from originating consumers via communication interfaces. Each content object interest message requests first desired content and identifies the first desired content using a first content name. The consumer communication module is also configured to receive content list interest messages from consumer devices via a communication network. Each content list interest message identifies second desired content using a second content name and requests a first content fingerprint list that identifies data chunks for the second desired content using fingerprint names. The consumer communication module is also configured to receive fingerprint interest messages from consumer devices via the communication network. Each fingerprint interest message requests a desired fingerprint object message using a first fingerprint name that represents a first data chunk of content data for a portion of third desired content. The source communication module configured to receive fingerprint list messages from source devices via the communication network. Each fingerprint list message identifies first select content using a third content name and includes a second content fingerprint list with fingerprint names representing data chunks of the first select content. The source communication module is also configured to receive fingerprint object messages from source devices via the communication network. Each fingerprint object message includes a second fingerprint name and a second data chunk such that the second fingerprint name represents the second data chunk which represents content data for a portion of second select content. The message processing controller configured to control the consumer communication module, source communication module, local storage device, message routing module, fingerprint list processing module, and object caching module in conjunction with processing content object interest messages, content list interest messages, fingerprint list messages, fingerprint interest messages, and fingerprint object messages.

In still another aspect, a non-transitory computer-readable medium storing program instructions is provided. The program instructions, when executed by a computer, cause a corresponding computer-controlled CCN message processing subsystem in a network device within a communication network to perform a method for reducing content redundancy in CCN. In one embodiment, the method includes: processing a content object interest message in response to receiving the content object interest message from an originating consumer via a communication interface, wherein the content object interest message requests first desired content and identifies the first desired content using a first content name; processing a content list interest message in response to receiving the content list interest message from a first consumer device via a communication network, wherein the content list interest message identifies second desired content using a second content name and requests a first content fingerprint list that identifies data chunks for the second desired content using fingerprint names; processing a fingerprint list message in response to receiving the fingerprint list message from a first source device via the communication network, wherein the fingerprint list message identifies first select content using a third content name and includes a second content fingerprint list with fingerprint names representing data chunks of the first select content; processing a fingerprint interest message in response to receiving the fingerprint interest message from a second consumer device via the communication network, wherein the fingerprint interest message requests a desired fingerprint object message using a first fingerprint name that represents a first data chunk of content data for a portion of third desired content; and processing a fingerprint object message in response to receiving the fingerprint object message from a second source device via the communication network, wherein the fingerprint object message includes a second fingerprint name and a second data chunk such that the second fingerprint name represents the second data chunk which represents content data for a portion of second select content.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a diagram showing exemplary content data divided into chunks and fingerprint names for the chunks for two exemplary items of named content;

FIG. 2 is a functional diagram showing exemplary messaging between a host server and a consumer for distribution of data chunks for two exemplary items of named content based on content names;

FIG. 3 is a functional diagram showing exemplary messaging between a host server and a consumer for distribution of data chunks for two exemplary items of named content based on fingerprint names;

FIG. 4 is a flow chart of an exemplary embodiment of a process for reducing content redundancy in content-centric networking (CCN);

FIG. 5 is a diagram showing an exemplary messaging flow o distribution of fingerprint object messages for a first item of named content;

FIG. 6 is a diagram showing an exemplary messaging flow for distribution of fingerprint object messages for a second item of named content;

FIG. 7 is a diagram showing another exemplary messaging flow for distribution of fingerprint object messages for a first item of named content;

FIG. 8 is a diagram showing another exemplary messaging flow for distribution of fingerprint object messages for a second item of named content;

FIG. 9 is a flow chart of another exemplary embodiment of a process for reducing content redundancy in CCN;

FIG. 10, in combination with FIG. 9 or FIG. 12, is a flow chart of yet another exemplary embodiment of a process for reducing content redundancy in CCN;

FIG. 11 is a flow chart of still another exemplary embodiment of a process for reducing content redundancy in CCN;

FIG. 12 is a flow chart of still yet another exemplary embodiment of a process for reducing content redundancy in CCN;

FIG. 13 is a flow chart of another exemplary embodiment of a process for reducing content redundancy in CCN;

FIG. 14 is a flow chart of yet another exemplary embodiment of a process for reducing content redundancy in CCN;

FIG. 15 is a block diagram of an exemplary embodiment of a system for reducing content redundancy in CCN;

FIG. 16 is a block diagram of an exemplary embodiment of a CCN message processing subsystem for a network device;

FIG. 17 is a diagram showing yet another exemplary messaging flow for distribution of fingerprint object messages for a first item of named content; and

FIG. 18 is a diagram showing still another exemplary messaging flow for distribution of fingerprint object messages for a first item of named content.

### DETAILED DESCRIPTION

Various embodiments of a system, content-centric networking (CCN) message processing subsystem, and methods for reducing content redundancy in CCN provide a content-based caching mechanism to eliminate (or at least reduce) redundant data common to multiple documents that would otherwise be cached in the network multiple times. The elimination or reduction of certain redundant data being cached improves the overall efficiency of a CCN network in terms of the storage, bandwidth, and energy costs.

The various embodiments of methods and apparatus disclosed herein provide a solution to identify and eliminate (or reduce) redundant data transmission and caching in a CCN network. The exemplary solutions described herein may be referred to as CCN redundancy elimination (CCN-RE) solutions and existing solutions may be referred to as CCN solutions. Empirical evidence suggests that there is a significant amount of common content in data from the same source (ranging from 30% to 70% of the total data), and hence our approach is expected to reduce cache sizes by this amount and also lead to bandwidth savings in terms of data transferred over the network.

The basic idea of CCN-RE is to index data in a cache based on the content rather than the name of the content. Content here refers to a document or a portion of a document. In CCN-RE, the content that is common to several documents is identified and assigned a unique fingerprint using the content itself (similar to hashing a document). As a result, a document is decomposed into a sequence of fingerprints. Whenever a user requests a document, the request for the document is transformed into multiple requests for chunks referred to by these fingerprints. As a result, common chunks of data only need to be transferred and stored once. This process eliminates or at least reduces the duplicated content in the network. For example, Rabin fingerprinting techniques may be used to identify the common content and assign it a fingerprint. For additional information on Rabin fingerprinting techniques, refer to Rabin, Fingerprinting by Random Polynomials, Center for Research in Computing Technology, Harvard University, Technical Report TR-15-81 (1981), 14 pages, the contents of which are fully incorporated herein by reference.

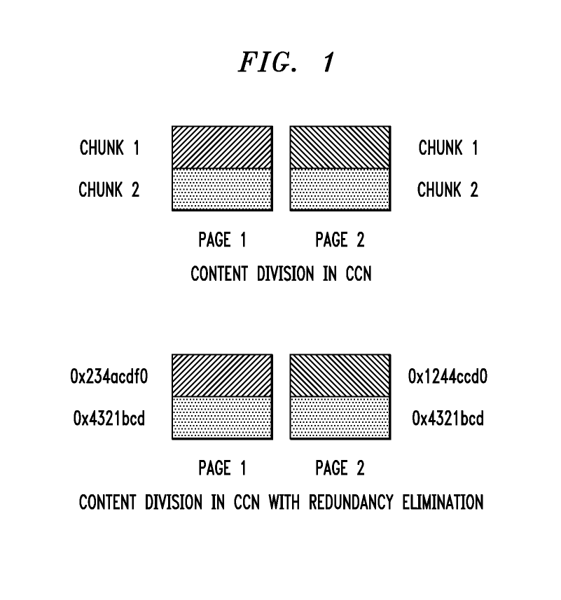

With reference to FIGS. 1-3, the processes involved in both CCN and CCN-RE are described using an example where a client requests two documents, namely “<backslash> lucent <dot> com <backslash> page1 <dot> html” and “<backslash> lucent <dot> com <backslash> page2 <dot> html,” hosted at server “lucent <dot> com.” This example easily extends to multiple servers, users and documents.

Currently, in a process for communicating content using CCN, the client sends a request for “<backslash> lucent <dot> com <backslash> page1 <dot> html” and the CCN network routes the request towards the closest copy based on the document name. For example, this copy of “<backslash> lucent <dot> com <backslash> page1 <dot> html” is hosted at the “lucent <dot> com” server. The server indicates that the requested document is composed of two chunks: 1) “<backslash> lucent <dot> com <backslash> page1 <dot> chunk1” and 2) “<backslash> lucent <dot> com <backslash> page1 <dot> chunk2.” The server also indicates that the client should request both chunks. FIG. 1 shows the division of each page into chunks in CCN.

The client sends requests for both chunks of the document “<backslash> lucent <dot> com <backslash> page1 <dot> html.” The server replies to the chunk requests with the actual chunks, and both chunks are cached along the path in each router, i.e., 2 chunks and 2,000 bytes.

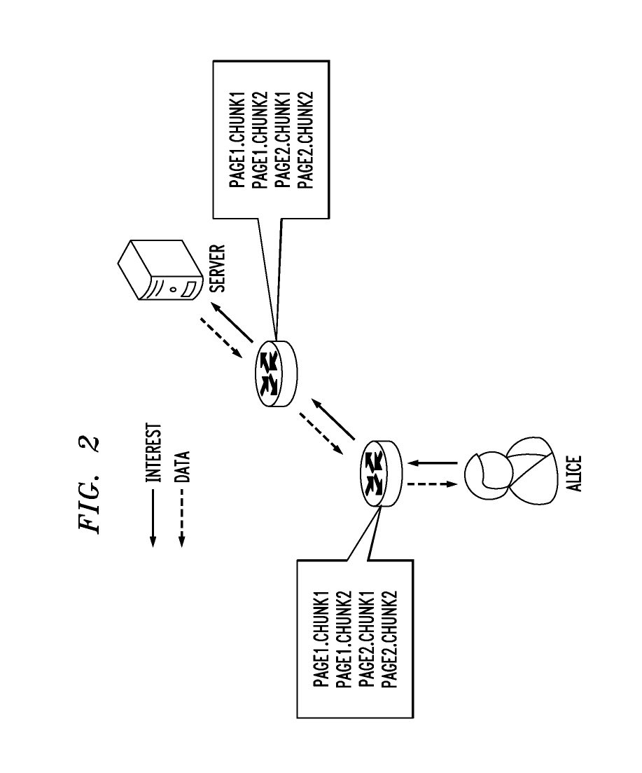

The client sends a new request for “<backslash> lucent <dot> com <backslash> page2 <dot> html.” The same procedure is performed to request both chunks of the second document. In total, 4 chunks (two for page1 and two for page2) and 4,000 bytes of data are cached in the CCN network. FIG. 2 shows the content cached in the routers after Alice requests both pages from the server.

In a process for communicating content using CCN-RE, the server divides each page into a collection of chunks. Each chunk is given a name based on the Rabin fingerprint of that chunk. For instance, continuing the example before, the document with name “<backslash> lucent <dot> com <backslash> page1 <dot> html” is divided in two chunks. The first 1,000 bytes of the document are unique to page1 and the last 1,000 bytes are common to “page1 <dot> html” and “page2 <dot> html.” The chunks are named “<backslash> lucent <dot> com <backslash> page1 <dot> html <backslash> chunk <dot> 0x234acdf0” and “<backslash> lucent <dot> com <backslash> page1 <dot> html <backslash> chunk <dot>0x4321bcd.” The hexadecimal number after the “chunk” is the hash obtained by applying a Rabin fingerprinting algorithm on the two chunks. Similarly, “<backslash> lucent <dot> com <backslash> page2 <dot> html” includes two chunks named: “<backslash> lucent <dot> com <backslash> page2 <dot> html <backslash> chunk <dot> 0x1244ccd0” and “<backslash> lucent <dot> com <backslash> page2 <dot> html <backslash> chunk <dot> 0x4321bcd.” The second chunk has the same name in both page1 <dot> html and page2 <dot> html as it is indeed the same content. FIG. 1 shows how the content is divided in CCN-RE.

The rest of the CCN protocol remains the same. For additional information on the CCN protocol, see CCNx Protocol, Palo Alto Research Center, (PARC), Inc., Palo Alto, Calif., printed from “www <dot> ccnx <dot> org <backslash> releases <backslash> latest <backslash> doc <backslash> technical <backslash> CCNxProtocol <dot> html” on Apr. 6, 2012, last revised May 4, 2011, 7 pages, the contents of which are fully incorporated herein by reference.

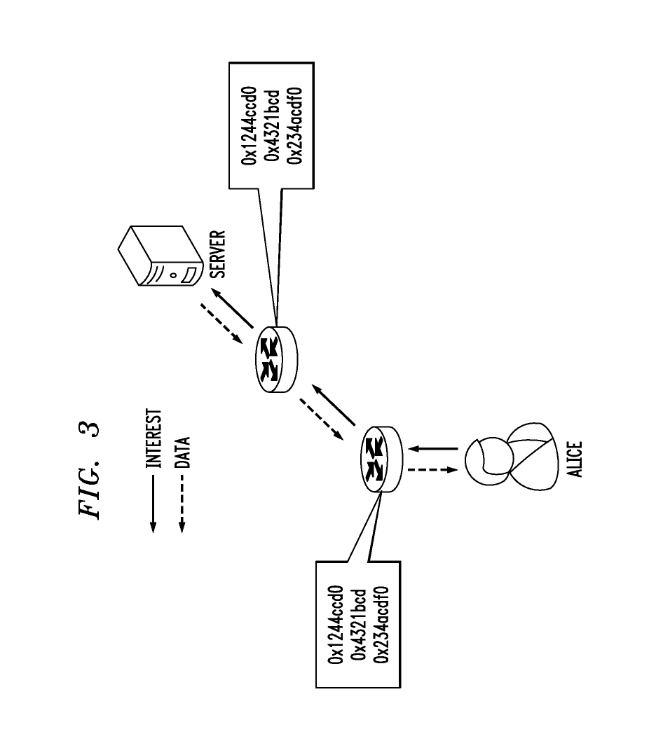

Under the CCE-RE process, the user requests “<backslash> lucent <dot> com <backslash> page1 <dot> html” first, and requests for the individual chunks that makeup the page are generated. The server sends the chunks which get cached by the routers. The key used to cache every chunk is the hash obtained by applying the Rabin fingerprint. The same happens for “<backslash> lucent <dot> com <backslash> page2 <dot> html.” Based on the naming mechanism in CCE-RE, the routers only cache 3,000 bytes. In other words, chunk <dot> 0x4321 bcd is common to both page1 <dot> html and page2 <dot> html and is cached only once. Instead of caching 4,000 bytes, as in the original CCN protocol, only 3,000 bytes are cached. Similarly, only 3,000 bytes are transmitted over the first link. The second chunk of “<backslash> lucent <dot> com <backslash> page2 <dot> html” is in fact already cached by the first router which satisfies the request without contacting the original server. FIG. 3 shows the state of the system after Alice requests both the pages using CCN-RE.

The benefit of CCN-RE is evident from the savings in the above example. In reality, however, much higher savings than what the example shows above is expected. This approach leads to savings in terms of the data transferred over the links, the data stored on the routers, and ultimately savings in terms of the energy required to operate these network elements.

The various embodiments of processes and components for reducing content redundancy in CCN disclosed herein can significantly reduce the storage requirements on routers, reduce the amount of data transferred over communication links within the network, and reduce the total energy consumed by the system. A savings of 30 to 70 percent in bandwidth and storage costs is also expected.

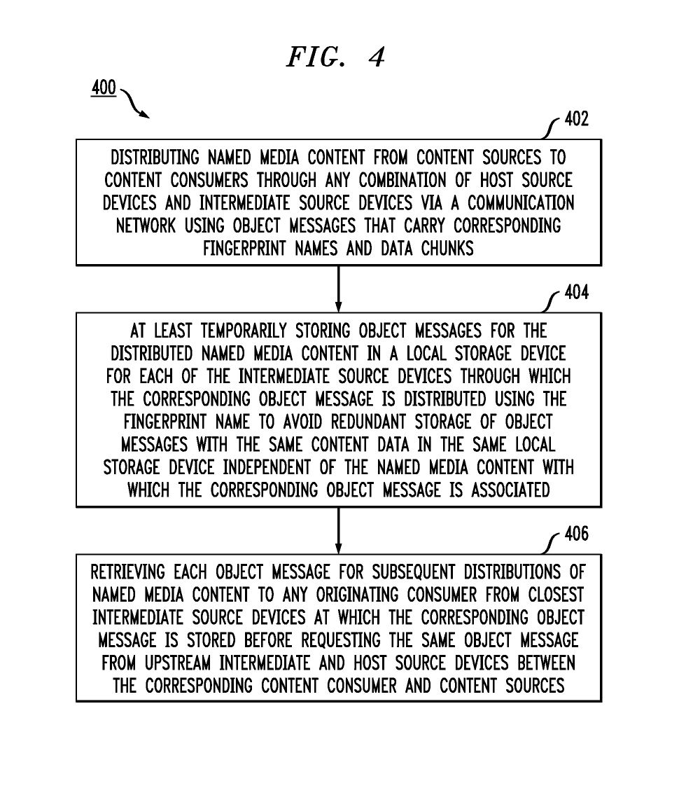

Referring again to the drawings wherein the showings are for purposes of illustrating the exemplary embodiments only and not for purposes of limiting the claimed subject matter, FIG. 4 depicts an exemplary embodiment of a process 400 for reducing content redundancy in CCN that begins at 402 where named media content or another type of content is distributed from content sources to content consumers through any combination of host source devices and intermediate source devices via a communication network using object messages that carry corresponding fingerprint names and data chunks. The named content is divisible into data chunks that are represented by corresponding fingerprint names such that a content fingerprint list for chosen content identifies the data chunks for the chosen content using the corresponding fingerprint names. The fingerprint names are based on content data in the corresponding data chunk such that data chunks with the same content data for the same chosen content and for other named content are represented by the same fingerprint name and data chunks with different content data are represented by different fingerprint names.

Next, the process may at least temporarily store object messages for the distributed named content in a local storage device for each of the intermediate source devices through which the corresponding object message is distributed using the fingerprint name to avoid redundant storage of object messages with the same content data in the same local storage device independent of the named content with which the corresponding object message is associated (404). At 406, the process may also include retrieving each object message for subsequent distributions of named content to any originating consumer from closest intermediate source devices at which the corresponding object message is stored before requesting the same object message from upstream intermediate and host source devices between the corresponding content consumer and content sources (406).

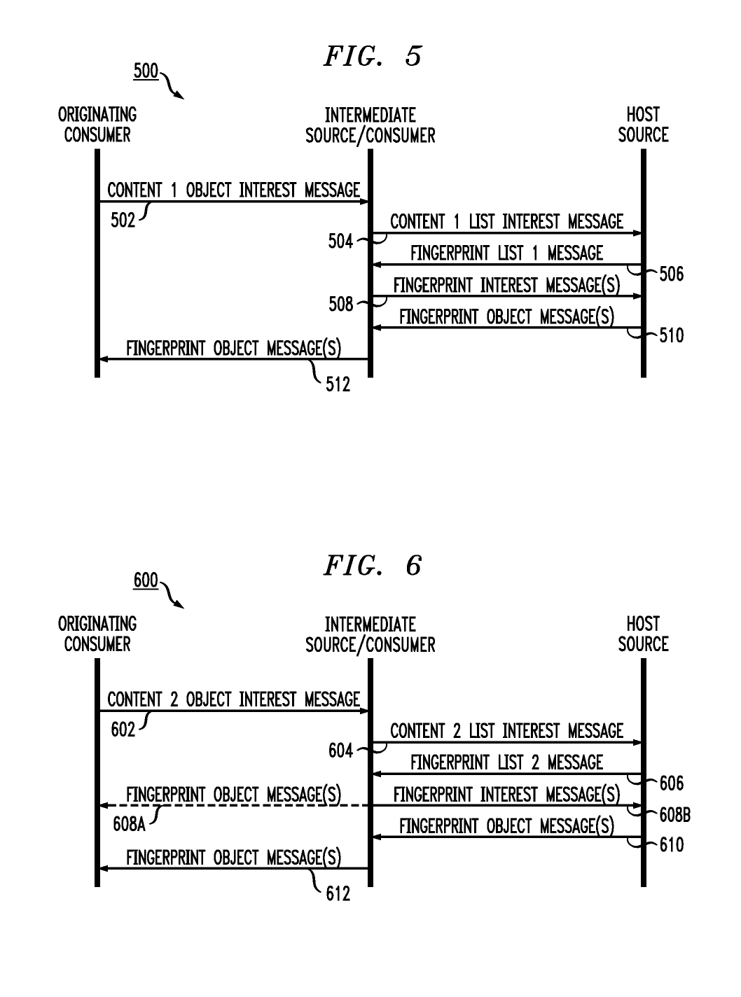

With reference to FIG. 5, an exemplary messaging flow 500 for distribution of fingerprint object messages for a first item of media content or another type of content (content 1) begins at an originating consumer. The originating consumer, for example, may be a client device with an application module that initiated an action that prompted generation of a request for content 1.

In this scenario, the originating consumer does not include a CCN message processing subsystem that caches fingerprint object messages for content. Under these circumstances, the originating consumer sends a content 1 object interest message 502 to an intermediate source. The content 1 object interest message 502 requests content 1 and identifies content 1 using a content name. The intermediate source, for example, may be a serving device or a routing device.

In this scenario, the intermediate source includes a CCN message processing subsystem that caches fingerprint object messages for content. The intermediate source does not have a content fingerprint list for content 1 stored locally. Under these circumstances, the intermediate source, acting as an intermediate consumer, sends a content 1 list interest message 504 to a host source. The content 1 list interest message 504 identifies content 1 using the content name and requests a content fingerprint list that identifies data chunks for content 1 using fingerprint names. The host source, for example, is a host device with a local storage device in which content 1 is stored. The host source also includes a content source processing subsystem configured to divide content 1 into data chunks, generate fingerprints for the data chunks, and generate a fingerprint list for content 1.

The host source sends a fingerprint list 1 message 506 to the intermediate consumer in response to message 504. The fingerprint 1 list message 506 identifies content 1 using the content name and includes a content fingerprint list with fingerprint names representing data chunks of content 1. The intermediate consumer stores the content fingerprint list for content 1 in a local storage device and begins processing the list.

In this scenario, the intermediate consumer does not have any fingerprint object messages for content 1 stored locally. Under these circumstances, the intermediate consumer sends a fingerprint interest message 508 for each fingerprint name in the content fingerprint list to the host source. Each fingerprint interest message 508 requests a fingerprint object message using the fingerprint name that represents a data chunk of content data for a portion of content 1.

In response to each message 508, the host source sends a corresponding fingerprint object message 510 to the intermediate consumer. Each fingerprint object message 510 includes a fingerprint name and a data chunk such that the fingerprint name represents the data chunk which represents content data for a portion of content 1. Upon receiving each message 510, the intermediate consumer stores the corresponding fingerprint object message 510 in the local storage device and, acting as an intermediate source, forwards the corresponding fingerprint object message 512 to the originating consumer.

With reference to FIG. 6, an exemplary messaging flow 600 for distribution of fingerprint object messages for a second item of media content or another type of content (content 2) begins at an originating consumer. For example, this scenario may use the same originating consumer, intermediate source/consumer, and host source as the scenario for content 1 described above with reference to FIG. 5. In this scenario, the originating consumer sends a content 2 object interest message 602 to an intermediate source. The content 2 object interest message 602 requests content 2 and identifies content 2 using a content name.

In this scenario, the intermediate source does not have a content fingerprint list for content 2 stored locally. Under these circumstances, the intermediate source, acting as an intermediate consumer, sends a content 2 list interest message 604 to a host source. The content 2 list interest message 604 identifies content 2 using the content name and requests a content fingerprint list that identifies data chunks for content 2 using fingerprint names.

The host source sends a fingerprint list 2 message 606 to the intermediate consumer in response to message 604. The fingerprint 2 list message 606 identifies content 2 using the content name and includes a content fingerprint list with fingerprint names representing data chunks of content 2. The intermediate consumer stores the content fingerprint list for content 2 in a local storage device and begins processing the list.

In this scenario, at least some data chunks for content 2 have the same content data as data chunks for content 1. Therefore, the content fingerprint lists for content 1 and content 2 have at least some fingerprint names that are common to both lists. Under these circumstances, because the intermediate source/consumer previously processed messages in conjunction with a request for content 1, the intermediate source/consumer has at least some fingerprint object messages for content 2 stored locally.

In conjunction with processing the content fingerprint list, for each fingerprint name, the intermediate consumer determines if the corresponding fingerprint object message is stored in the local storage device. If the corresponding fingerprint object message is stored locally, the intermediate consumer, acting as an intermediate source, sends the locally stored fingerprint object message 608A to the originating consumer. Each fingerprint object message 608A includes a fingerprint name and a data chunk such that the fingerprint name represents the data chunk which represents content data for a portion of content 2. Conversely, if the corresponding fingerprint object message is not stored locally, the intermediate consumer sends a fingerprint interest message 608B for the corresponding fingerprint name in the content fingerprint list to the host source. Each fingerprint interest message 608B requests a fingerprint object message using the fingerprint name that represents a data chunk of content data for a portion of content 2.

In response to each message 608B, the host source sends a corresponding fingerprint object message 610 to the intermediate consumer. Upon receiving each message 610, the intermediate consumer stores the corresponding fingerprint object message 610 in the local storage device and, acting as an intermediate source, forwards the corresponding fingerprint object message 612 to the originating consumer.

With reference to FIG. 17, an exemplary messaging flow 1700 for distribution of fingerprint object messages for a first item of media content or another type of content (content 1) begins at an originating consumer. For example, this scenario uses the same intermediate source/consumer and occurs after the scenario for content 1 described above with reference to FIG. 5. In this scenario, the originating consumer sends a content 1 object interest message 1702 to an intermediate source. The content 1 object interest message 1 702 requests content 1 and identifies content 1 using a content name.

In this scenario, the intermediate source previously processed messages in conjunction with a previous request for content 1, still has a content fingerprint list for content 1 stored locally, and still has at least some fingerprint object messages for content 1 stored locally. Under these circumstances, the content 1 list interest message (504) and fingerprint list 1 message (506) described in FIG. 5 are not needed. After receiving the content 1 object interest message 1702, the intermediate source begins processing the content fingerprint list for content 1 from local storage.

In conjunction with processing the content fingerprint list, for each fingerprint name, the intermediate source determines if the corresponding fingerprint object message is stored in the local storage device. If the corresponding fingerprint object message is stored locally, the intermediate source sends the locally stored fingerprint object message 1708A to the originating consumer. Each fingerprint object message 1708A includes a fingerprint name and a data chunk such that the fingerprint name represents the data chunk which represents content data for a portion of content 1. Conversely, if the corresponding fingerprint object message is not stored locally, the intermediate source, acting as an intermediate consumer, sends a fingerprint interest message 1708B for the corresponding fingerprint name in the content fingerprint list to the host source. Each fingerprint interest message 1708B requests a fingerprint object message using the fingerprint name that represents a data chunk of content data for a portion of content 1.

In response to each message 1708B, the host source sends a corresponding fingerprint object message 1710 to the intermediate consumer. Upon receiving each message 1710, the intermediate consumer stores the corresponding fingerprint object message 1710 in the local storage device and, acting as an intermediate source, forwards the corresponding fingerprint object message 1712 to the originating consumer,

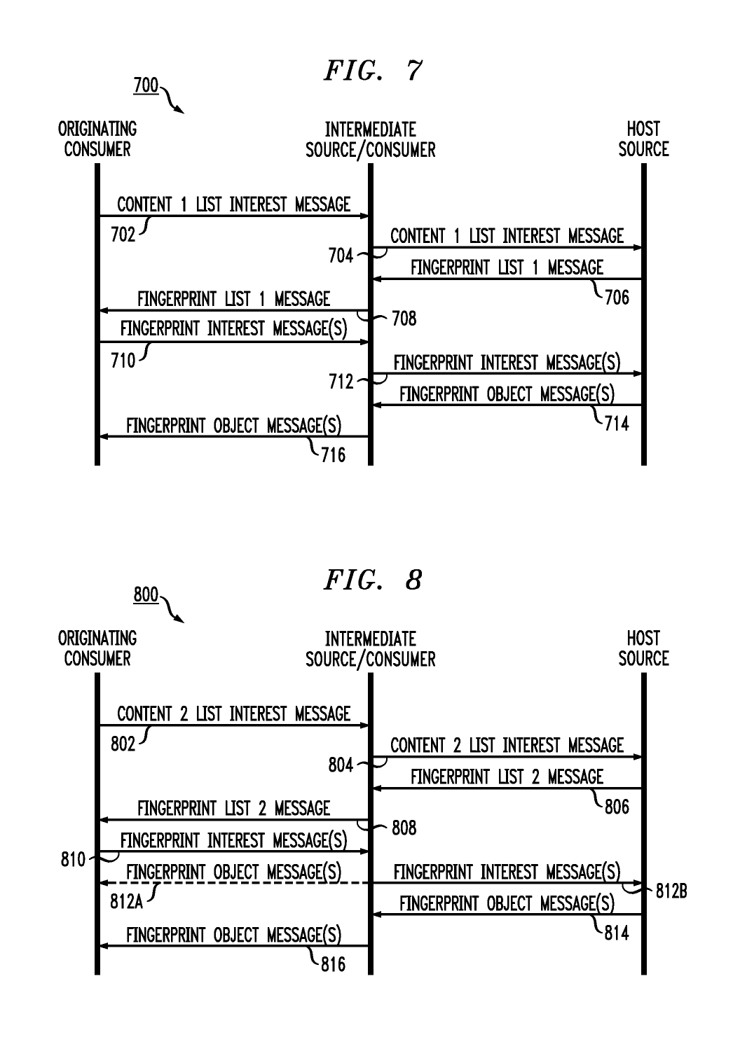

With reference to FIG. 7, another exemplary messaging flow 700 for distribution of fingerprint object messages for a first item of media content or another type of content (content 1) begins at an originating consumer. The originating consumer, for example, may be a client device with an application module that initiated an action that prompted generation of a request for content 1.

In this scenario, the originating consumer also includes a CCN message processing subsystem that caches fingerprint object messages for content. However, the originating consumer does not have a content fingerprint list for content 1 stored locally within the CCN message processing subsystem. Under these circumstances, the originating consumer sends a content 1 list interest message 702 to an intermediate source. The content 1 list interest message 702 identifies content 1 using a content name and requests a content fingerprint list that identifies data chunks for content 1 using fingerprint names. The intermediate source, for example, may be a serving device or a routing device.

In this scenario, the intermediate source also includes a CCN message processing subsystem that caches fingerprint object messages for content. The intermediate source does not have the content fingerprint list for content 1 stored locally. Under these circumstances, the intermediate source, acting as an intermediate consumer, forwards the content 1 list interest message 704 to a host source. The host source, for example, is a host device with a local storage device in which content 1 is stored. The host source also includes a content source processing subsystem configured to divide content 1 into data chunks, generate fingerprints for the data chunks, and generate a fingerprint list for content 1.

The host source sends a fingerprint list 1 message 706 to the intermediate consumer in response to message 704. The fingerprint 1 list message 706 identifies content 1 using the content name and includes a content fingerprint list with fingerprint names representing data chunks of content 1. The intermediate consumer stores the content fingerprint list for content 1 in a local storage device and forwards the fingerprint list 1 message 708 to the originating consumer. The CCN message processing subsystem within the originating consumer stores the content fingerprint list for content 1 in a local storage device and begins processing the list.

In this scenario, the CCN message processing subsystem within the originating consumer does not have any fingerprint object messages for content 1 stored locally. Under these circumstances, the originating consumer sends a fingerprint interest message 710 for each fingerprint name in the content fingerprint list to the intermediate source. Each fingerprint interest message 710 requests a fingerprint object message using the fingerprint name that represents a data chunk of content data for a portion of content 1. In this scenario, the intermediate source does not have any fingerprint object messages for content 1 stored locally. Under these circumstances, the intermediate source, acting as an intermediate consumer, forwards the fingerprint interest message 712 for each fingerprint name in the content fingerprint list to the host source.

In response to each message 712, the host source sends a corresponding fingerprint object message 714 to the intermediate consumer. Each fingerprint object message 714 includes a fingerprint name and a data chunk such that the fingerprint name represents the data chunk which represents content data for a portion of content 1. Upon receiving each message 714, the intermediate consumer stores the corresponding fingerprint object message 714 in the local storage device and, acting as an intermediate source, forwards the corresponding fingerprint object message 716 to the originating consumer. Upon receiving each message 716, the CCN message processing module within the originating source stores the corresponding fingerprint object message 716 in the local storage device and forwards the corresponding fingerprint object message 716 toward the application module within the originating consumer.

With reference to FIG. 8, another exemplary messaging flow 800 for distribution of fingerprint object messages for a second item of media content or another type of content (content 2) begins at an originating consumer. For example, this scenario may use the same intermediate source/consumer and host source as the scenario for content 1 described above with reference to FIG. 7. However, this scenario may use a different originating consumer than the scenario for content 1 described above with reference to FIG. 7. The originating consumer in this scenario may have similar characteristics to the originating consumer of FIG. 7. For example, the originating consumer may be a client device with an application module that initiated an action that prompted generation of a request for content 2.

In this scenario, the originating consumer also includes a CCN message processing subsystem that caches fingerprint object messages for content. However, the originating consumer does not have a content fingerprint list for content 2 stored locally within the CCN message processing subsystem. Under these circumstances, the originating consumer sends a content 2 list interest message 802 to an intermediate source. The content 2 list interest message 802 identifies content 2 using a content name and requests a content fingerprint list that identifies data chunks for content 2 using fingerprint names.

In this scenario, the intermediate source does not have the content fingerprint list for content 2 stored locally. Under these circumstances, the intermediate source, acting as an intermediate consumer, forwards the content 2 list interest message 804 to a host source.

The host source sends a fingerprint list 2 message 806 to the intermediate consumer in response to message 804. The fingerprint 2 list message 706 identifies content 2 using the content name and includes a content fingerprint list with fingerprint names representing data chunks of content 2. The intermediate consumer stores the content fingerprint list for content 2 in a local storage device and forwards the fingerprint list 2 message 808 to the originating consumer. The CCN message processing subsystem within the originating consumer stores the content fingerprint list for content 2 in a local storage device and begins processing the list.

In this scenario, the CCN message processing subsystem within the originating consumer does not have any fingerprint object messages for content 2 stored locally. Under these circumstances, the originating consumer sends a fingerprint interest message 810 for each fingerprint name in the content fingerprint list to the intermediate source. Each fingerprint interest message 810 requests a fingerprint object message using the fingerprint name that represents a data chunk of content data for a portion of content 2.

In this scenario, at least some data chunks for content 2 have the same content data as data chunks for content 1. Therefore, the content fingerprint lists for content 1 and content 2 have at least some fingerprint names that are common to both lists. Under these circumstances, because the intermediate source/consumer previously processed messages in conjunction with a request for content 1, the intermediate source/consumer has at least some fingerprint object messages for content 2 stored locally.

In conjunction with processing each fingerprint interest message 810 received from the originating consumer, the intermediate source determines if the requested fingerprint object message is stored in the local storage device. If the corresponding fingerprint object message is stored locally, the intermediate source sends the locally stored fingerprint object message 812A to the originating consumer. Each fingerprint object message 812A includes a fingerprint name and a data chunk such that the fingerprint name represents the data chunk which represents content data for a portion of content 2. Conversely, if the requested fingerprint object message is not stored locally, the intermediate source, acting as an intermediate consumer, forwards the fingerprint interest message 812B for the corresponding fingerprint name in the content fingerprint list to the host source.

In response to each message 812B, the host source sends a corresponding fingerprint object message 814 to the intermediate consumer. Upon receiving each message 814, the intermediate consumer stores the corresponding fingerprint object message 814 in the local storage device and, acting as an intermediate source, forwards the corresponding fingerprint object message 816 to the originating consumer. Upon receiving each message 816, the CCN message processing module within the originating source stores the corresponding fingerprint object message 816 in the local storage device and forwards the corresponding fingerprint object message 816 toward the application module within the originating consumer.

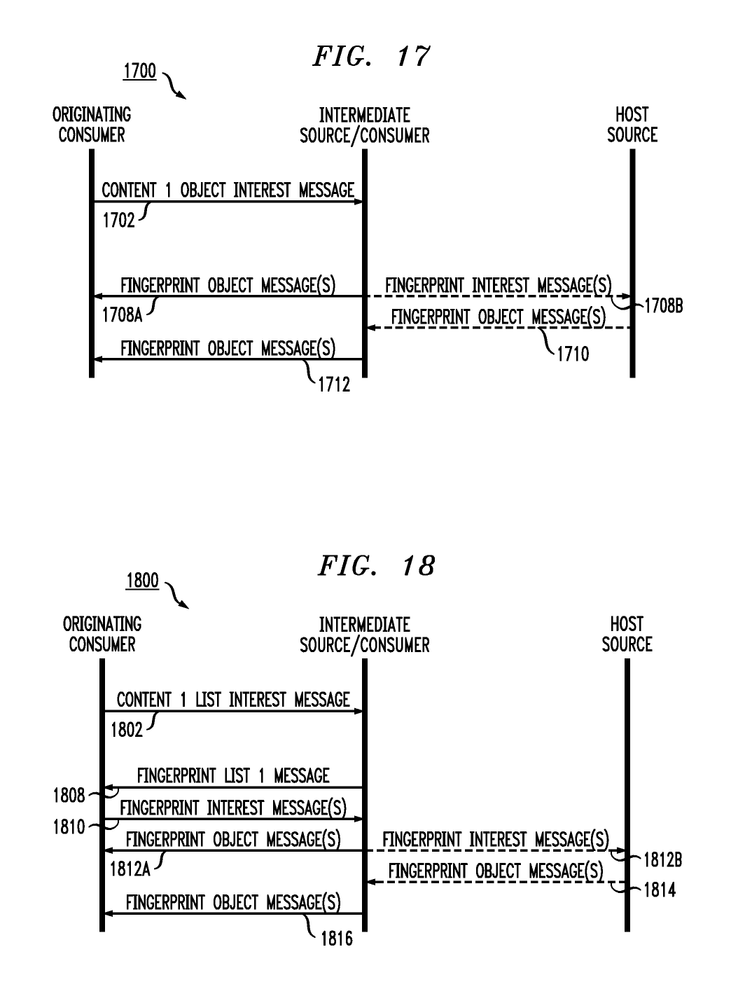

With reference to FIG. 18, another exemplary messaging flow 1800 for distribution of fingerprint object messages for a first item of media content or another type of content (content 1) begins at an originating consumer. For example, this scenario uses the same intermediate source/consumer and occurs after the scenario for content 1 described above with reference to FIG. 7. However, this scenario may use a different originating consumer than the scenario for content 1 described above with reference to FIG. 7. The originating consumer in this scenario may have similar characteristics to the originating consumer of FIG. 7. For example, the originating consumer may be a client device with an application module that initiated an action that prompted generation of a request for content 1.

In this scenario, the originating consumer also includes a CCN message processing subsystem that caches fingerprint object messages for content. However, the originating consumer does not have a content fingerprint list for content 1 stored locally within the CCN message processing subsystem. Under these circumstances, the originating consumer sends a content 1 list interest message 1802 to an intermediate source. The content 1 list interest message 1802 identifies content 1 using a content name and requests a content fingerprint list that identifies data chunks for content 1 using fingerprint names.

In this scenario, the intermediate source previously processed message in conjunction with a previous request for content 1, still has a content fingerprint list for content 1 stored locally, and still has at least some fingerprint object messages for content 1 stored locally. Under these circumstances, the content 1 list interest message (704) and fingerprint 1 list message (706) described in FIG. 7 are not needed. After receiving the content 1 list interest message 1802, the intermediate source sends the fingerprint list 1 message 1808 to the originating consumer. The CCN message processing subsystem within the originating consumer stores the content fingerprint list for content 1 in a local storage device and begins processing the list.

In this scenario, the CCN message processing subsystem within the originating consumer does not have any fingerprint object messages for content 1 stored locally. Under these circumstances, the originating consumer sends a fingerprint interest message 1810 for each fingerprint name in the content fingerprint list to the intermediate source. Each fingerprint interest message 1810 requests a fingerprint object message using the fingerprint name that represents a data chunk of content data for a portion of content 1.

In this scenario, the intermediate source still has at least some fingerprint object messages for content 1 stored locally. In conjunction with processing each fingerprint interest message 1810 received from the originating consumer, the intermediate source determines if the requested fingerprint object message is stored in the local storage device. If the corresponding fingerprint object message is stored locally, the intermediate source sends the locally stored fingerprint object message 1812A to the originating consumer. Each fingerprint object message 1812A includes a fingerprint name and a data chunk such that the fingerprint name represents the data chunk which represents content data for a portion of content 1. Conversely, if the requested fingerprint object message is not stored locally, the intermediate source, acting as an intermediate consumer, forwards the fingerprint interest message 1812B for the corresponding fingerprint name in the content fingerprint list to the host source.

In response to each message 1812B, the host source sends a corresponding fingerprint object message 1814 to the intermediate consumer. Upon receiving each message 1814, the intermediate consumer stores the corresponding fingerprint object message 1814 in the local storage device and, acting as an intermediate source, forwards the corresponding fingerprint object message 1816 to the originating consumer. Upon receiving each message 1816, the CCN message processing module within the originating source stores the corresponding fingerprint object message 1816 in the local storage device and forwards the corresponding fingerprint object message 1816 toward the application module within the originating consumer.

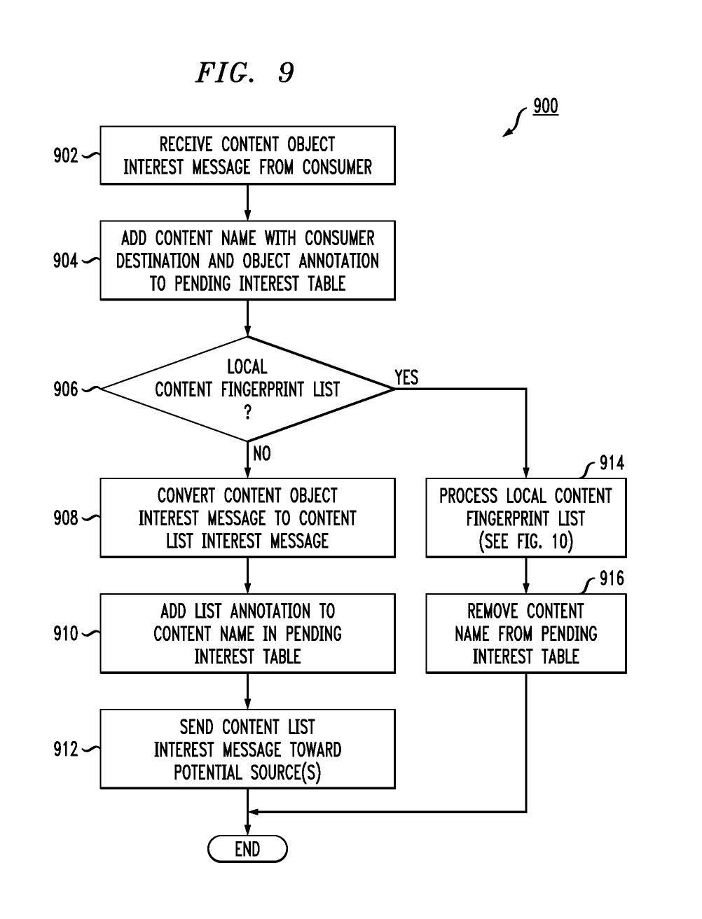

With reference to FIG. 9, another exemplary embodiment of a process 900 for reducing content redundancy in CCN begins at 902 where a content object interest message is received from an originating consumer at a source device via a communication interface. The content object interest message requests desired media content or another type of content and identifies the desired content using a content name. At 904, the content name associated with the content object interest message is added to a pending interest table in a local storage device at the source device. The content name added to the pending interest table is annotated with a consumer destination associated with the originating consumer and an object annotation. Next, the process determines if a content fingerprint list for the desired content is stored in the local storage device (906). If the content fingerprint list is not stored locally, the process advances to 908 where the content object interest message is converted to a content list interest message that identifies the desired content using the content name and includes a request for the content fingerprint list. At 910, the content name added to the pending interest table is annotated with a list annotation. Next, the content list interest message is sent from the source device toward one or more potential sources of the content fingerprint list via a communication network (912).

If the content fingerprint list is stored locally at 906, the process advances to 914 where each fingerprint name in the local content fingerprint list is processed to selectively send fingerprint object messages to the originating consumer or fingerprint interest messages toward one or more potential sources of the corresponding fingerprint object messages. At 916, the content name is removed from the pending interest table after the last fingerprint name in the local content fingerprint list is processed.

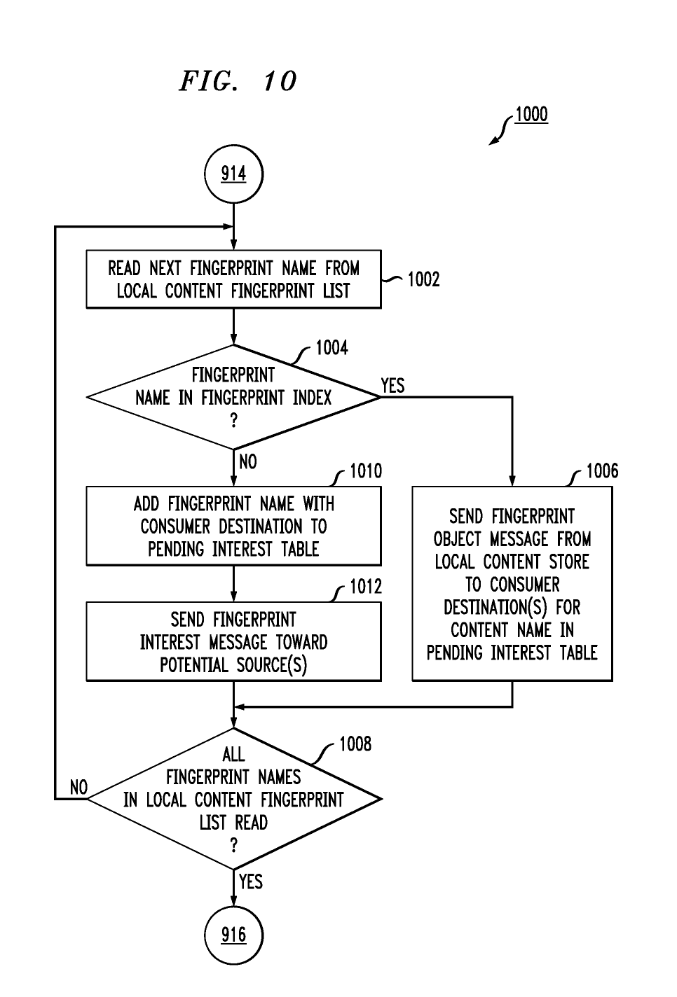

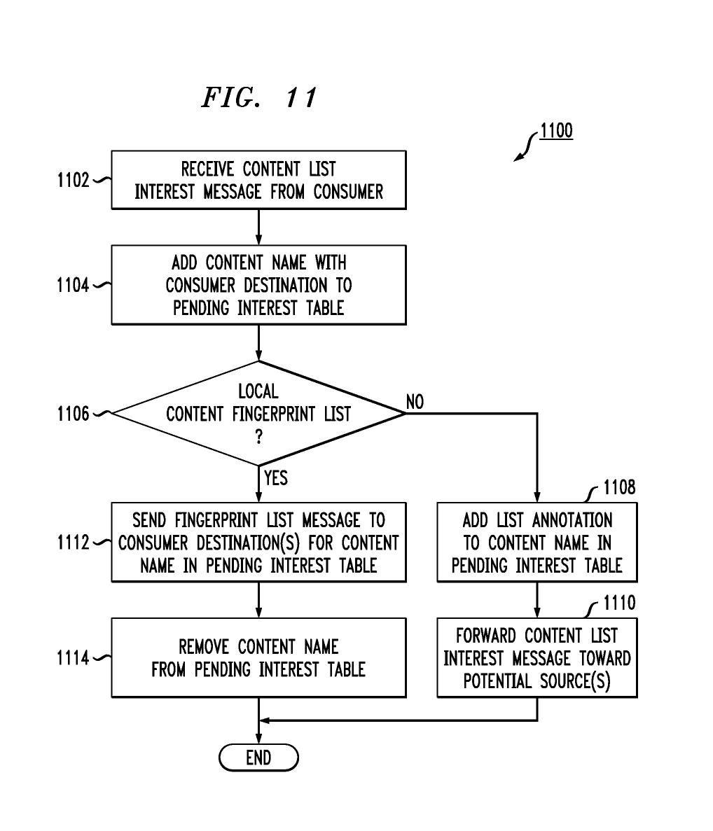

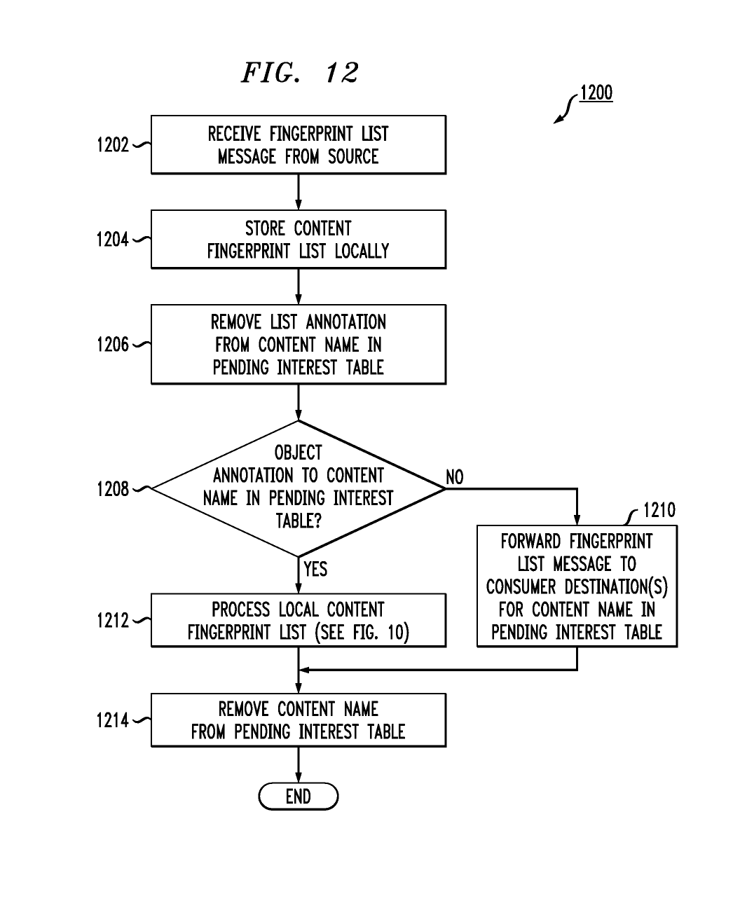

With reference to FIGS. 9 and 10, another embodiment of process 900 continues from 914 to a sub-process 1000 depicted in FIG. 10. The sub-process 1000 begins at 1002 where the processing of each fingerprint name in the content fingerprint list includes reading a next fingerprint name from the local content fingerprint list. Next, the process determines if the read fingerprint name is stored in a fingerprint index in the local storage device (1004). If the read fingerprint name is stored in the fingerprint index, the process advances to 1006 where a fingerprint object message associated with the read fingerprint name is sent from a local content store in the local storage device to the consumer destination associated with the originating consumer. Next, the process determines if all fingerprint names in the local content fingerprint list have been read (1008). If all fingerprint names have not been read, the process returns to 1002 to repeat the processing of the content fingerprint list for the next fingerprint name. If all fingerprint names have been read at 1008, the process returns to 916 of FIG. 9.

If the read fingerprint name is not stored in the fingerprint index at 1004, the process advances to 1010 where the read fingerprint name is added to the pending interest table in the local storage device. The fingerprint name added to the pending interest table is annotated with the consumer destination associated with the originating consumer. At 1012, a fingerprint interest message is sent from the source device toward one or more potential sources of the fingerprint object message associated with the read fingerprint name via the communication network. Next, the process determines if all fingerprint names in the local content fingerprint list have been read (1008). If all fingerprint names have not been read, the process returns to 1002 to repeat the processing of the content fingerprint list for the next fingerprint name. If all fingerprint names have been read at 1008, the process returns to 916 of FIG. 9.

With reference to FIG. 11, still another exemplary embodiment of a process 1100 for reducing content redundancy in CCN begins at 1102 where a content list interest message is received from a consumer device at a source device via a communication network. The content list interest message identifies desired media content or another type of content using a content name and requests a content fingerprint list that identifies data chunks for the desired content using fingerprint names. At 1104, the content name from the content list interest message is added to a pending interest table in a local storage device at the source device. The content name added to the pending interest table is annotated with a consumer destination associated with the consumer device. Next, the process determines if the requested content fingerprint list is stored in the local storage device (1106). If the content fingerprint list is not stored locally, the process advances to 1108 where the content name added to the pending interest table is annotated with a list annotation. At 1110, the content list interest message is forwarded from the source device toward one or more potential sources of the content fingerprint list via the communication network.

If the content fingerprint list is stored locally at 1106, the process advances 1112 where a fingerprint list message with the requested content fingerprint list is sent to the consumer destination associated with the content name in the pending interest table. At 1114, the content name is removed from the pending interest table.

With reference to FIG. 12, still yet another exemplary embodiment of a process 1200 for reducing content redundancy in CCN begins at 1202 where a fingerprint list message is received from a source device at a consumer device via a communication network. The fingerprint list message identifies select media content or another type of content using a content name and includes a content fingerprint list with fingerprint names representing data chunks of the select content. Next, the content fingerprint list is stored in a local storage device at the consumer device (1204). At 1206, a list annotation is removed from a content name stored in a pending interest table in the local storage device. Next, the process determines if the content name in the pending interest table is annotated with an object annotation (1208). If the content name is not annotated with the object annotation, the process advances to 1210 where the fingerprint list message is forwarded from the consumer device to a consumer destination associated with the content name in the pending interest table. At 1214, the content name is removed from the pending interest table.

If the content name is annotated with the object annotation at 1208, the process advances to 1212 where each fingerprint name in the content fingerprint list is processed to selectively send fingerprint object messages toward an originating consumer or fingerprint interest messages toward one or more potential sources of the corresponding fingerprint object messages. Next, the content name is removed from the pending interest table after the last fingerprint name in the content fingerprint list is processed (1214).

With reference to FIGS. 12 and 10, another embodiment of process 1200 continues from 1212 to 1002 where the processing of each fingerprint name in the content fingerprint list includes reading a next fingerprint name from the local content fingerprint list. Next, the process determines if the read fingerprint name is stored in a fingerprint index in the local storage device (1004). If the read fingerprint name is stored in the fingerprint index, the advances to 1006 where a fingerprint object message associated with the read fingerprint name is sent from a local content store in the local storage device to a consumer destination associated with the content name in the pending interest table. Next, the process determines if all fingerprint names in the local content fingerprint list have been read (1008). If all fingerprint names have not been read, the process returns to 1002 to repeat the processing of the content fingerprint list for the next fingerprint name. If all fingerprint names have been read at 1008, the process returns to 1214 of FIG. 12.

If the read fingerprint name is not stored in the fingerprint index at 1004, the process advances to 1010 where the read fingerprint name is added to the pending interest table in the local storage device. The fingerprint name added to the pending interest table is annotated with the consumer destination associated with the content name in the pending interest table. At 1012, a fingerprint interest message is sent from the source device toward one or more potential sources of the fingerprint object message associated with the read fingerprint name via the communication network. Next, the process determines if all fingerprint names in the local content fingerprint list have been read (1008). If all fingerprint names have not been read, the process returns to 1002 to repeat the processing of the content fingerprint list for the next fingerprint name. If all fingerprint names have been read at 1008, the process returns to 1214 of FIG. 12.

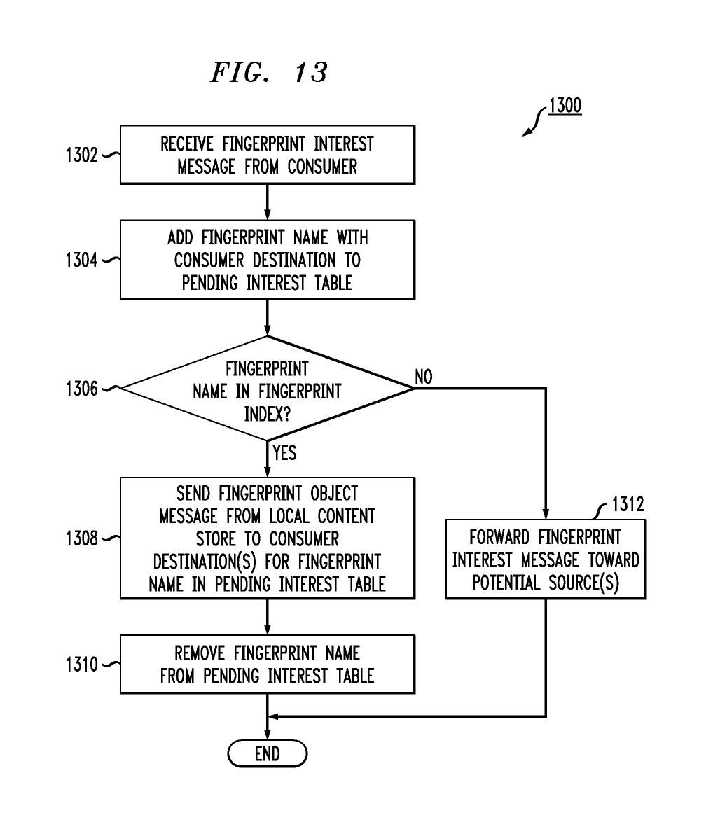

With reference to FIG. 13, another exemplary embodiment of a process 1300 for reducing content redundancy in CCN begins at 1302 where a fingerprint interest message is received from a consumer device at a source device via a communication network. The fingerprint interest message requests a fingerprint object message using a fingerprint name that represents a data chunk of content data for a portion of desired media content or another type of content. At 1304, the fingerprint name from the fingerprint interest message is added to a pending interest table in a local storage device at the source device. The fingerprint name added to the pending interest table is annotated with a consumer destination associated with the consumer device. Next, the process determines if the fingerprint name is stored in a fingerprint index in the local storage device (1306). If the fingerprint name is stored in the fingerprint index, the process advances to 1308 where the fingerprint object message associated with the fingerprint name is sent from a local content store in the local storage device to the consumer destination associated with the fingerprint name in the pending interest table. At 1310, the fingerprint name is removed from the pending interest table.

If the fingerprint name is not stored in the fingerprint index at 1306, the process advances to 1312 where the fingerprint interest message is forwarded from the source device toward one or more potential sources of the fingerprint object message associated with the fingerprint name via the communication network.

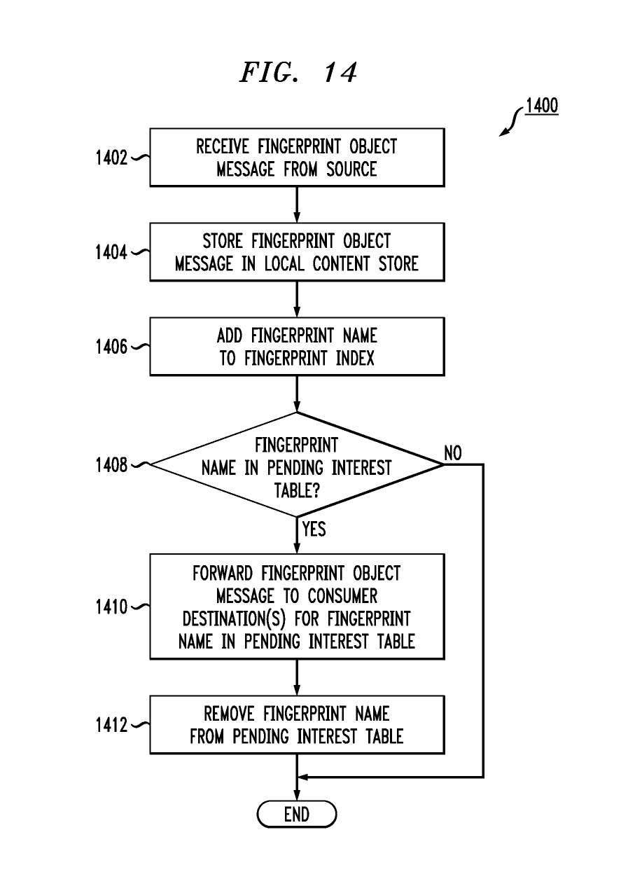

With reference to FIG. 14, yet another exemplary embodiment of a process 1400 for reducing content redundancy in CCN begins at 1402 where a fingerprint object message is received from a source device at a consumer device via a communication network. The fingerprint object message includes a fingerprint name and a data chunk such that the fingerprint name represents the data chunk which represents content data for a portion of select media content or another type of content. Next, the fingerprint object message is stored in a local content store in a local storage device at the consumer device (1404). At 1406, the fingerprint name is added to a fingerprint index in the local storage device. Next, the process determines if the fingerprint name is stored in a pending interest table in the local storage device (1408). If the fingerprint name is stored in the pending interest table, the process to 1410 where the fingerprint object message is forwarded from the consumer device to a consumer destination associated with the fingerprint name in the pending interest table. At 1412, the fingerprint name is removed from the pending interest table. If the fingerprint name is not stored in the pending interest table at 1408, the process is ended.

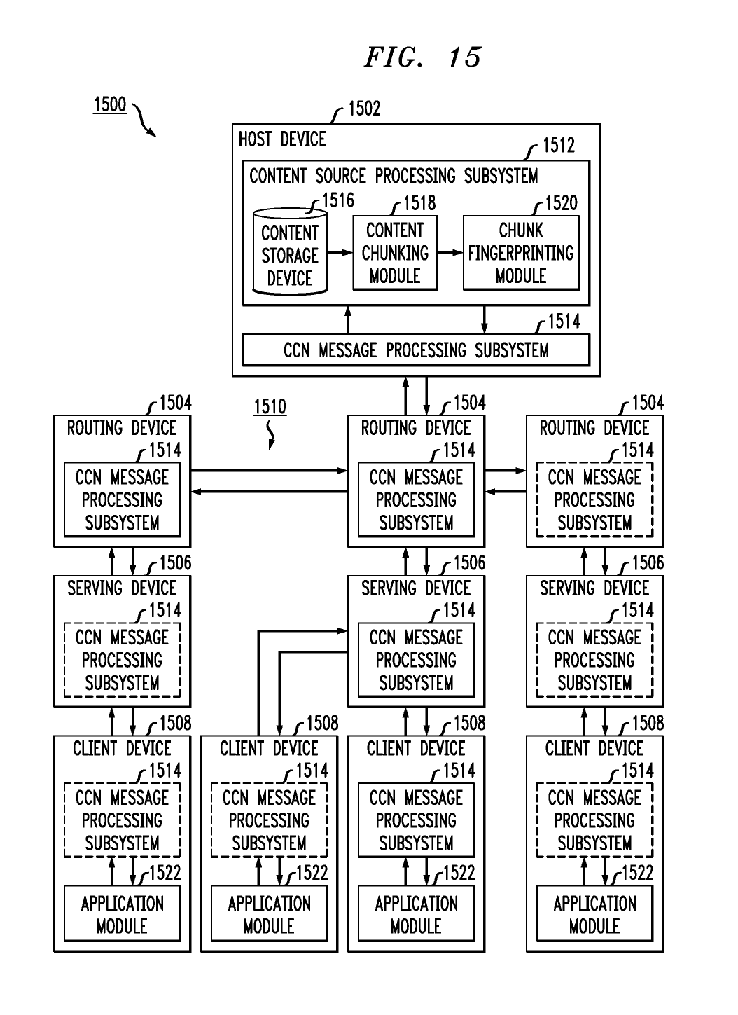

With reference to FIG. 15, an exemplary embodiment of a system 1500 for reducing content redundancy in CCN includes host source devices (e.g., host device 1502), intermediate source devices (e.g., routing device 1504, serving device 1506, or client device 1508), and a communication network 1510. The communication network 1510 interconnecting the host source devices 1502 and intermediate source devices 1504, 1506, 1508. Host source devices 1502 may include a content source processing subsystem 1512 and a CCN message processing subsystem 1514. The content source processing subsystem includes a content storage device 1516, a content chunking module 1518, and a chunk fingerprinting module 1520. The CCN message processing subsystem 1514 includes a local content storage device. Each intermediate source device 1504, 1506, 1508 may include a CCN message processing module 1514.

The system 1500 is configured to distribute named media content or another type of content from content sources to content consumers through any combination of host source devices 1502 and intermediate source devices 1504, 1506, 1508 via the communication network 1510 using object messages that carry corresponding fingerprint names and data chunks. Host devices 1502 are content sources. If a CCN message processing subsystem 1514 is included in a routing device 1504, serving device 1506, or client devices 1508 that device may also serve as a content source to content consumers farther from the host device 1502. Application modules 1522 in client devices 1508 are content consumers. If a CCN message processing subsystem 1514 is included in a routing device 1504, serving device 1506, or client devices 1508 that device may also serve as a content consumer to content sources closer to the host device 1502. Routing devices 1504, serving devices 1506, and client devices 1508 that do not include a CCN message processing subsystem 1514 may simply pass through messages from content consumers to content sources and vice versa without performing any CCN operations.

CCN operations are facilitated by the content source processing subsystem 1512 because the named content in the content storage device 1516 is divisible into data chunks by the content chunking module 1518 that are represented by corresponding fingerprint names assigned by the chunk fingerprinting module 1520 such that a content fingerprint list for chosen content identifies the data chunks for the chosen content using the corresponding fingerprint names. The fingerprint names are based on content data in the corresponding data chunk such that data chunks with the same content data for the same chosen content and for other named content are represented by the same fingerprint name and data chunks with different content data are represented by different fingerprint names.

In another embodiment of the system 1500, each intermediate source device 1504, 1506, 1508 through which the object messages for the named content are distributed is configured to at least temporarily store the object messages in the local storage device using the corresponding fingerprint names in a manner that avoids redundant storage of object messages with the same content data in the same local storage device independent of the named content with which the corresponding object message is associated. The system 1500 is configured to retrieve each object message for subsequent distributions of named content to any originating consumer from closest intermediate source devices at which the corresponding object message is stored before requesting the same object message from upstream intermediate and host source devices 1502 between the corresponding content consumer and content sources.

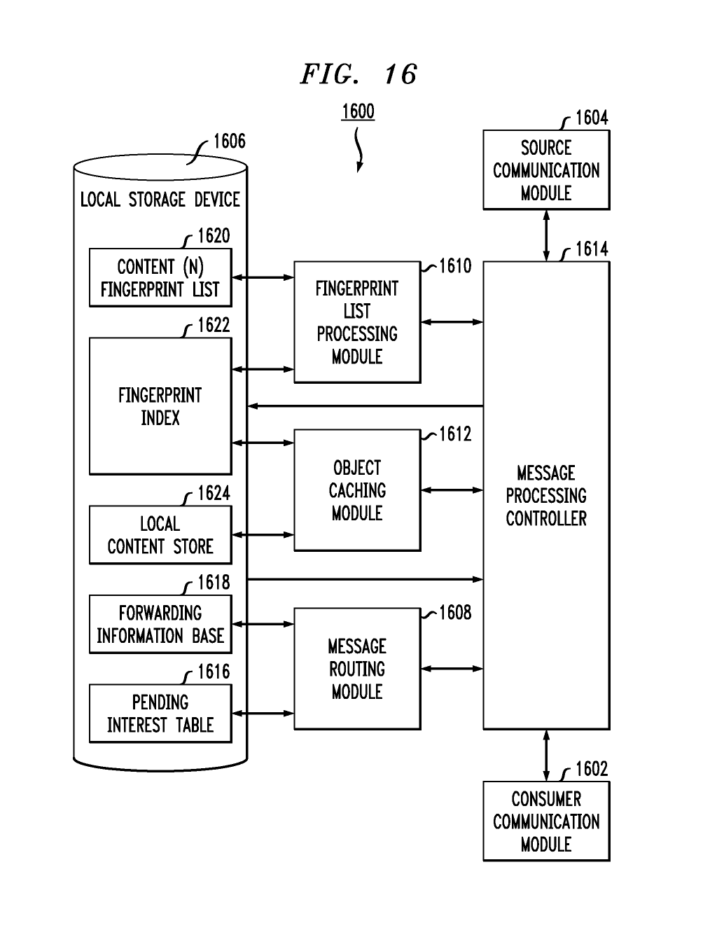

With reference to FIG. 16, an exemplary embodiment of a CCN message processing subsystem 1600 for reducing content redundancy in CCN includes a consumer communication module 1602, a source communication module 1604, a local storage device 1606, a message routing module 1608, a fingerprint list processing module 1610, an object caching module 1612, and a message processing controller 1614. The CCN message processing subsystem may be a component of various types of network devices (e.g., host devices, routing devices, serving devices, client devices, etc.) in any suitable combination within a communication network.

The consumer communication module 1602 configured to receive content object interest messages from originating consumers via communication interfaces. Each content object interest message requests first desired media content or another type of content and identifies the first desired content using a first content name. The consumer communication module 1602 is also configured to receive content list interest messages from consumer devices via a communication network. Each content list interest message identifies second desired content using a second content name and requests a first content fingerprint list that identifies data chunks for the second desired content using fingerprint names. The consumer communication module 1602 is also configured to receive fingerprint interest messages from consumer devices via the communication network. Each fingerprint interest message requests a desired fingerprint object message using a first fingerprint name that represents a first data chunk of content data for a portion of third desired content.

The source communication module 1604 configured to receive fingerprint list messages from source devices via the communication network. Each fingerprint list message identifies first select content using a third content name and includes a second content fingerprint list with fingerprint names representing data chunks of the first select content. The source communication module 1604 is also configured to receive fingerprint object messages from source devices via the communication network. Each fingerprint object message includes a second fingerprint name and a second data chunk such that the second fingerprint name represents the second data chunk which represents content data for a portion of second select content.

The message processing controller 1614 configured to control the consumer communication module 1602, source communication module 1604, local storage device 1606, message routing module 1608, fingerprint list processing module 1610, and object caching module 1612 in conjunction with processing content object interest messages, content list interest messages, fingerprint list messages, fingerprint interest messages, and fingerprint object messages.

In another embodiment of the CCN message processing subsystem 1600, the consumer communication module 1602 is configured to receive a content object interest message from an originating consumer via a communication interface. The content object interest message requests desired content and identifies the desired content using a content name. In this embodiment, the message processing controller 1614 is configured to i) receive the content object interest message from the consumer communication module 1602, ii) add the content name associated with the content object interest message to a pending interest table 1616 in the local storage device 1606, iii) annotate the content name added to the pending interest table 1616 with a consumer destination associated with the originating consumer and an object annotation, and iv) determine if a content fingerprint list for the desired content is stored in the local storage device 1606. In conjunction with the content fingerprint list not being stored locally, the message processing controller 1614 is configured to i) convert the content object interest message to a content list interest message that identifies the desired content using the content name and includes a request for the content fingerprint list, ii) annotate the content name added to the pending interest table 1616 with a list annotation, and iii) control the message routing module 1608 and source communication module 1604 to send the content list interest message toward one or more potential sources of the content fingerprint list via a communication network. For example, potential sources of the content fingerprint list may be obtained from storage in the forwarding information base 1618 of the local storage device 1606.

In a further embodiment of the CCN message processing subsystem 1600, in conjunction with the content fingerprint list 1620 being stored locally, the message processing controller 1614 is configured to i) control the fingerprint list processing module 1610, object caching module 1612, and message routing module 1608 to process each fingerprint name in the local content fingerprint list 1620 to selectively send fingerprint object messages to the originating consumer via the consumer communication module 1602 or fingerprint interest messages toward one or more potential sources of the corresponding fingerprint object messages via the source communication module 1604 and ii) remove the content name from the pending interest table 1616 after the last fingerprint name in the local content fingerprint list 1620 is processed. For example, potential sources of the corresponding fingerprint object messages may be obtained from storage in the forwarding information base 1618 of the local storage device 1606.

In an even further embodiment of the CCN message processing subsystem 1600, in conjunction with the processing of each fingerprint name in the content fingerprint list 1620, the message processing controller 1614 is configured to i) control the fingerprint list processing module 1610 to read a next fingerprint name from the local content fingerprint list 1620 and ii) determine if the read fingerprint name is stored in a fingerprint index 1622 in the local storage device 1606. In conjunction with the read fingerprint name being stored in the fingerprint index 1622, the message processing controller 1614 is configured to i) control the object caching module 1612, message routing module 1608, and consumer communication module 1602 to send a fingerprint object message associated with the read fingerprint name from a local content store 1624 in the local storage device 1606 to the consumer destination associated with the originating consumer and ii) control the fingerprint list processing module 1610 to determine if all fingerprint names in the local content fingerprint list 1620 have been read. If all fingerprint names have not been read, the message processing controller 1614 is configured to repeat the processing of the content fingerprint list 1620 for the next fingerprint name.

In an even yet further embodiment of the CCN message processing subsystem 1600, the message processing controller 1614 is configured, if the read fingerprint name is not stored in the fingerprint index 1622, to i) add the read fingerprint name to the pending interest table 1616 in the local storage device 1606, ii) annotate the fingerprint name added to the pending interest table 1616 with the consumer destination associated with the originating consumer, iii) control the message routing module 1608 and source communication module 1604 to send a fingerprint interest message toward one or more potential sources of the fingerprint object message associated with the read fingerprint name via the communication network, and iv) control the fingerprint list processing module 1610 to determine if all fingerprint names in the local content fingerprint list 1620 have been read. For example, potential sources of the fingerprint object message may be obtained from storage in the forwarding information base 1618 of the local storage device 1606. The message processing controller 1614 is configured to repeat the processing of the content fingerprint list 1620 for the next fingerprint name if all fingerprint names have not been read.

In yet another embodiment of the CCN message processing subsystem 1600, the consumer communication module 1602 is configured to receive a content list interest message from a consumer device via the communication network. The content list interest message identifies desired content using a content name and requests a content fingerprint list that identifies data chunks for the desired content using fingerprint names. The message processing controller 1614 is configured to i) receive the content list interest message from the consumer communication module 1602, ii) add the content name from the content list interest message to a pending interest table 1616 in the local storage device 1606, iii) annotate the content name added to the pending interest table 1616 with a consumer destination associated with the consumer device, and iv) determine if the requested content fingerprint list is stored in the local storage device 1606. The message processing controller 1614 is configured, if the content fingerprint list is not stored locally, to i) annotate the content name added to the pending interest table 1616 with a list annotation and ii) control the message routing module 1608 and source communication module 1604 to forward the content list interest message toward one or more potential sources of the content fingerprint list via the communication network. For example, potential sources of the content fingerprint list may be obtained from storage in the forwarding information base 1618 of the local storage device 1606.

In a further embodiment of the CCN message processing subsystem 1600, the message processing controller 1614 is configured, if the content fingerprint list 1622 is stored locally, to i) control the fingerprint list processing module 1610, message routing module 1608, and consumer communication module 1602 to send a fingerprint list message with the requested content fingerprint list to the consumer destination associated with the content name in the pending interest table 1616 and ii) remove the content name from the pending interest table, i

In still another embodiment of the CCN message processing subsystem 1600, the source communication module 1604 is configured to receive a fingerprint list message from a source device via the communication network. The fingerprint list message identifies select content using a content name and includes a content fingerprint list with fingerprint names representing data chunks of the select content. The message processing controller 1614 is configured to i) receive the fingerprint list message from the source communication module 1604, ii) store the content fingerprint list 1620 in the local storage device 1622, iii) remove a list annotation from a content name stored in a pending interest table 1616 in the local storage device 1606, wherein the content name identifies the select content media, and iv) determine if the content name in the pending interest table 1616 is annotated with an object annotation. The message processing controller 1614 is configured, if the content name is not annotated with the object annotation, to i) control the message routing module 1608 and consumer communication module 1602 to forward the fingerprint list message to a consumer destination associated with the content name in the pending interest table 1616 and ii) remove the content name from the pending interest table 1616.

In a further embodiment of the CCN message processing subsystem 1600, the message processing controller 1614 is configured, if the content name is annotated with the object annotation, to control the fingerprint list processing module 1610, object caching module 1612, and message routing module 1608 to process each fingerprint name in the content fingerprint list to selectively send fingerprint object messages toward an originating consumer via the consumer communication module 1602 or fingerprint interest messages toward one or more potential sources of the corresponding fingerprint object messages via the source communication module 1604 and ii) remove the content name from the pending interest table 1616 after the last fingerprint name in the content fingerprint list 1620 is processed. For example, potential sources of the corresponding fingerprint object messages may be obtained from storage in the forwarding information base 1618 of the local storage device 1606.

In an even further embodiment of the CCN message processing subsystem 1600, the message processing controller 1614 is configured to control the processing of each fingerprint name in the content fingerprint list 1620 by i) controlling the fingerprint list processing module 1610 to read a next fingerprint name from the local content fingerprint list 1620 and ii) determining if the read fingerprint name is stored in a fingerprint index 1622 in the local storage device 1606. The message processing controller 1614 is configured, if the read fingerprint name is stored in the fingerprint index 1622, to i) control the object caching module 1612, message routing module 1608, and consumer communication module 1602 to send a fingerprint object message associated with the read fingerprint name from a local content store 1624 in the local storage device 1606 to a consumer destination associated with the content name in the pending interest table 1616 and ii) control the fingerprint list processing module 1610 to determine if all fingerprint names in the local content fingerprint list 1620 have been read. The message processing controller 1614 is configured to repeat the processing of the content fingerprint list 1620 for the next fingerprint name if all fingerprint names have not been read.

In an even yet further embodiment of the CCN message processing subsystem 1600, the message processing controller 1614 is configured, if the read fingerprint name is not stored in the fingerprint index 1622, to i) add the read fingerprint name to the pending interest table 1616 in the local storage device 1606, ii) annotate the fingerprint name added to the pending interest table 1616 with the consumer destination associated with the content name in the pending interest table 1616, iii) control the message routing module 1608 and source communication module 1604 to send a fingerprint interest message toward one or more potential sources of the fingerprint object message associated with the read fingerprint name via the communication network, and iv) control the fingerprint list processing module 1610 to determine if all fingerprint names in the local content fingerprint list 1620 have been read. For example, potential sources of the fingerprint object message may be obtained from storage in the forwarding information base 1618 of the local storage device 1606. The message processing controller 1614 is configured to repeat the processing of the content fingerprint list 1620 for the next fingerprint name if all fingerprint names have not been read.

In still yet another embodiment of the CCN message processing subsystem 1600, the consumer communication module 1602 is configured to receive a fingerprint interest message from a consumer device via the communication network. The fingerprint interest message requests a fingerprint object message using a fingerprint name that represents a data chunk of content data for a portion of desired content. The message processing controller 1614 is configured to i) add the fingerprint name from the fingerprint interest message to a pending interest table 1616 in the local storage device 1606, ii) annotate the fingerprint name added to the pending interest table 1616 with a consumer destination associated with the consumer device, and iii) determine if the fingerprint name is stored in a fingerprint index 1622 in the local storage device 1606. The message processing controller 1614 is configured, if the fingerprint name is stored in the fingerprint index 1622, to i) control the object caching module 1612, message routing module 1608, and consumer communication module 1602 to send the fingerprint object message associated with the fingerprint name from a local content store 1624 in the local storage device 1606 to the consumer destination associated with the fingerprint name in the pending interest table 1616 and ii) remove the fingerprint name from the pending interest table 1616.

In a further embodiment of the CCN message processing subsystem 1600, the message processing controller 1614 is configured, if the fingerprint name is not stored in the fingerprint index 1622, to control the message routing module 1608 and source communication module 1604 to forward the fingerprint interest message toward one or more potential sources of the fingerprint object message associated with the fingerprint name via the communication network. For example, potential sources of the fingerprint object message may be obtained from storage in the forwarding information base 1618 of the local storage device 1606.

In another embodiment of the CCN message processing subsystem 1600, the source communication module 1604 is configured to receive a fingerprint object message from a source device via the communication network. The fingerprint object message includes a fingerprint name and a data chunk such that the fingerprint name represents the data chunk which represents content data for a portion of select content. The message processing controller 1614 is configured to i) control the object caching module 1612 to store the fingerprint object message in a local content store 1624 in the local storage device 1606, ii) control the object caching module 1612 to add the fingerprint name to a fingerprint index 1622 in the local storage device 1606, and iii) determine if the fingerprint name is stored in a pending interest table 1616 in the local storage device 1606. The message processing controller 1614 is configured, if the fingerprint name is stored in the pending interest table 1616, to i) control the message routing module 1608 and consumer communication module 1602 to forward the fingerprint object message to a consumer destination associated with the fingerprint name in the pending interest table 1616 and ii) remove the fingerprint name from the pending interest table 1616.

With reference to FIGS. 1-16, an exemplary embodiment of a non-transitory computer-readable medium storing program instructions that, when executed by a computer, cause a corresponding computer-controlled CCN message processing subsystem in a network device within a communication network to perform a process for reducing content redundancy in CCN. In one exemplary embodiment, the process includes processing a content object interest message in response to receiving the content object interest message from an originating consumer via a communication interface, wherein the content object interest message requests first desired media content or another type of content and identifies the first desired content using a first content name.

The process also includes processing a content list interest message in response to receiving the content list interest message from a first consumer device via a communication network, wherein the content list interest message identifies second desired content using a second content name and requests a first content fingerprint list that identifies data chunks for the second desired content using fingerprint names. Additionally, the process includes processing a fingerprint list message in response to receiving the fingerprint list message from a first source device via the communication network, wherein the fingerprint list message identifies first select content using a third content name and includes a second content fingerprint list with fingerprint names representing data chunks of the first select content.

The process also includes processing a fingerprint interest message in response to receiving the fingerprint interest message from a second consumer device via the communication network, wherein the fingerprint interest message requests a desired fingerprint object message using a first fingerprint name that represents a first data chunk of content data for a portion of third desired content. Additionally, the process includes processing a fingerprint object message in response to receiving the fingerprint object message from a second source device via the communication network, wherein the fingerprint object message includes a second fingerprint name and a second data chunk such that the second fingerprint name represents the second data chunk which represents content data for a portion of second select content.

In various additional embodiments, the program instructions stored in the non-transitory computer-readable memory, when executed by the computer, may cause the computer-controlled CCN message processing subsystem to perform various combinations of functions associated with the processes 400, 900, 1000, 1100, 1200, 1300, 1400 for reducing content redundancy in CCN with reference to FIGS. 4 and 9-14. In other words, the various combinations of features from the embodiments of the processes described above may be implemented by the program instructions stored in the non-transitory computer-readable medium.

Likewise, in various embodiments, the program instructions stored in the non-transitory computer-readable medium, when executed by the computer, may cause the computer-controlled CCN message processing subsystem to perform various combinations of functions associated with the various embodiments of the system 1500 and CCN message processing subsystem 1600 described above with reference to FIGS. 15 and 16. Any suitable component described above with reference to FIGS. 15 and 16 may include the corresponding computer and non-transitory computer-readable medium associated with the corresponding program instructions. Alternatively, the corresponding computer and non-transitory computer-readable medium associated with the corresponding program instructions may be individual or combined components that are in operative communication with any suitable combination of the components described above with reference to FIGS. 15 and 16.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for reducing content redundancy in content-centric networking, comprising:
distributing named content from content sources to content consumers through any combination of host source devices and intermediate source devices via a communication network using object messages that carry corresponding fingerprint names and data chunks;
wherein the named content is divisible into data chunks that are represented by corresponding fingerprint names such that a content fingerprint list for chosen content identifies the data chunks for the chosen content using the corresponding fingerprint names;
wherein the fingerprint names are based on content data in the corresponding data chunk such that data chunks with the same content data for the same chosen content and for other named content are represented by the same fingerprint name and data chunks with different content data are represented by different fingerprint names.

2. The method of claim 1, further comprising:
at least temporarily storing object messages for the distributed named content in a local storage device for each of the intermediate source devices through which the corresponding object message is distributed using the fingerprint name to avoid redundant storage of object messages with the same content data in the same local storage device independent of the named content with which the corresponding object message is associated; and
retrieving each object message for subsequent distributions of named content to any originating consumer from closest intermediate source devices at which the corresponding object message is stored before requesting the same object message from upstream intermediate and host source devices between the corresponding content consumer and content sources.

3. The method of claim 1, further comprising:
receiving a content object interest message from an originating consumer at a source device via a communication interface, wherein the content object interest message requests desired content and identifies the desired content using a content name;
adding the content name associated with the content object interest message to a pending interest table in a local storage device at the source device;
annotating the content name added to the pending interest table with a consumer destination associated with the originating consumer and an object annotation;
determining if a content fingerprint list for the desired content is stored in the local storage device; and
if the content fingerprint list is not stored locally, the method further comprising:
converting the content object interest message to a content list interest message that identifies the desired content using the content name and includes a request for the content fingerprint list;
annotating the content name added to the pending interest table with a list annotation; and
sending the content list interest message from the source device toward one or more potential sources of the content fingerprint list via a communication network.

4. The method of claim 3, if the content fingerprint list is stored locally, the method further comprising:
processing each fingerprint name in the local content fingerprint list to selectively send fingerprint object messages to the originating consumer or fingerprint interest messages toward one or more potential sources of the corresponding fingerprint object messages; and
removing the content name from the pending interest table after the last fingerprint name in the local content fingerprint list is processed.

5. The method of claim 4, the processing of each fingerprint name in the content fingerprint list comprising:
reading a next fingerprint name from the local content fingerprint list;
determining if the read fingerprint name is stored in a fingerprint index in the local storage device;
if the read fingerprint name is stored in the fingerprint index, the method further comprising:
sending a fingerprint object message associated with the read fingerprint name from a local content store in the local storage device to the consumer destination associated with the originating consumer;
determining if all fingerprint names in the local content fingerprint list have been read; and
if all fingerprint names have not been read, repeating the processing of the content fingerprint list for the next fingerprint name.

6. The method of claim 5, if the read fingerprint name is not stored in the fingerprint index, the method further comprising:
adding the read fingerprint name to the pending interest table in the local storage device;
annotating the fingerprint name added to the pending interest table with the consumer destination associated with the originating consumer;
sending a fingerprint interest message from the source device toward one or more potential sources of the fingerprint object message associated with the read fingerprint name via the communication network;
determining if all fingerprint names in the local content fingerprint list have been read; and
if all fingerprint names have not been read, repeating the processing of the content fingerprint list for the next fingerprint name.

7. The method of claim 1, further comprising:
receiving a content list interest message from a consumer device at a source device via a communication network, wherein the content list interest message identifies desired content using a content name and requests a content fingerprint list that identifies data chunks for the desired content using fingerprint names;
adding the content name from the content list interest message to a pending interest table in a local storage device at the source device;
annotating the content name added to the pending interest table with a consumer destination associated with the consumer device;
determining if the requested content fingerprint list is stored in the local storage device; and
if the content fingerprint list is not stored locally, the method further comprising:
annotating the content name added to the pending interest table with a list annotation; and
forwarding the content list interest message from the source device toward one or more potential sources of the content fingerprint list via the communication network.

8. The method of claim 7, if he content fingerprint list is stored locally, the method further comprising:
sending a fingerprint list message with the requested content fingerprint list to the consumer destination associated with the content name in the pending interest table; and
removing the content name from the pending interest table.

9. The method of claim 1, further comprising:
receiving a fingerprint list message from a source device at a consumer device via a communication network, wherein the fingerprint list message identifies select content using a content name and includes a content fingerprint list with fingerprint names representing data chunks of the select content;
storing the content fingerprint list in a local storage device at the consumer device;
removing a list annotation from a content name stored in a pending interest table in the local storage device, wherein the content name identifies the select content media;
determining if the content name in the pending interest table is annotated with an object annotation; and
if the content name is not annotated with the object annotation, the method further comprising:
forwarding the fingerprint list message from the consumer device to a consumer destination associated with the content name in the pending interest table; and
removing the content name from the pending interest table.

10. The method of claim 9, if the content name is annotated with the object annotation, the method further comprising:
processing each fingerprint name in the content fingerprint list to selectively send fingerprint object messages toward an originating consumer or fingerprint interest messages toward one or more potential sources of the corresponding fingerprint object messages; and
removing the content name from the pending interest table after the last fingerprint name in the content fingerprint list is processed.

11. The method of claim 1, further comprising:
receiving a fingerprint interest message from a consumer device at a source device via a communication network, wherein the fingerprint interest message requests a fingerprint object message using a fingerprint name that represents a data chunk of content data for a portion of desired content;
adding the fingerprint name from the fingerprint interest message to a pending interest table in a local storage device at the source device;
annotating the fingerprint name added to the pending interest table with a consumer destination associated with the consumer device;
determining if the fingerprint name is stored in a fingerprint index in the local storage device; and
if the fingerprint name is stored in the fingerprint index, the method further comprising:
sending the fingerprint object message associated with the fingerprint name from a local content store in the local storage device to the consumer destination associated with the fingerprint name in the pending interest table; and
removing the fingerprint name from the pending interest table.

12. The method of claim 11, if the fingerprint name is not stored in the fingerprint index, the method further comprising:
forwarding the fingerprint interest message from the source device toward one or more potential sources of the fingerprint object message associated with the fingerprint name via the communication network.

13. The method of claim 1, further comprising:
receiving a fingerprint object message from a source device at a consumer device via a communication network, wherein the fingerprint object message includes a fingerprint name and a data chunk such that the fingerprint name represents the data chunk which represents content data for a portion of select content;
storing the fingerprint object message in a local content store in a local storage device at the consumer device;
adding the fingerprint name to a fingerprint index in the local storage device;
determining if the fingerprint name is stored in a pending interest table in the local storage device; and
if the fingerprint name is stored in the pending interest table, the method further comprising:
forwarding the fingerprint object message from the consumer device to a consumer destination associated with the fingerprint name in the pending interest table; and
removing the fingerprint name from the pending interest table.

14. An apparatus for reducing content redundancy in content-centric networking, comprising:
a consumer communication module configured to receive content object interest messages from originating consumers via communication interfaces, wherein each content object interest message requests first desired content and identifies the first desired content using a first content name, wherein the consumer communication module is also configured to receive content list interest messages from consumer devices via a communication network, wherein each content list interest message identifies second desired content using a second content name and requests a first content fingerprint list that identifies data chunks for the second desired content using fingerprint names, wherein the consumer communication module is also configured to receive fingerprint interest messages from consumer devices via the communication network, wherein each fingerprint interest message requests a desired fingerprint object message using a first fingerprint name that represents a first data chunk of content data for a portion of third desired content;
a source communication module configured to receive fingerprint list messages from source devices via the communication network, wherein each fingerprint list message identifies first select content using a third content name and includes a second content fingerprint list with fingerprint names representing data chunks of the first select content, wherein the source communication module is also configured to receive fingerprint object messages from source devices via the communication network, wherein each fingerprint object message includes a second fingerprint name and a second data chunk such that the second fingerprint name represents the second data chunk which represents content data for a portion of second select content;
a local storage device;
a message routing module;
a fingerprint list processing module;
an object caching module; and
a message processing controller configured to control the consumer communication module, source communication module, local storage device, message routing module, fingerprint list processing module, and object caching module in conjunction with processing content object interest messages, content list interest messages, fingerprint list messages, fingerprint interest messages, and fingerprint object messages.

15. The apparatus of claim 14 wherein the consumer communication module is configured to receive a content object interest message from an originating consumer via a communication interface, wherein the content object interest message requests desired content and identifies the desired content using a content name;
wherein the message processing controller is configured to i) receive the content object interest message from the consumer communication module, ii) add the content name associated with the content object interest message to a pending interest table in the local storage device, iii) annotate the content name added to the pending interest table with a consumer destination associated with the originating consumer and an object annotation, and iv) determine if a content fingerprint list for the desired content is stored in the local storage device;
wherein, in conjunction with the content fingerprint list not being stored locally, the message processing controller is configured to i) convert the content object interest message to a content list interest message that identifies the desired content using the content name and includes a request for the content fingerprint list, ii) annotate the content name added to the pending interest table with a list annotation, and iii) control the message routing module and source communication module to send the content list interest message toward one or more potential sources of the content fingerprint list via a communication network.

16. The apparatus of claim 14 wherein the consumer communication module is configured to receive a content list interest message from a consumer device via the communication network, wherein the content list interest message identifies desired content using a content name and requests a content fingerprint list that identifies data chunks for the desired content using fingerprint names;
wherein the message processing controller is configured to i) receive the content list interest message from the consumer communication module, ii) add the content name from the content list interest message to a pending interest table in the local storage device, iii) annotate the content name added to the pending interest table with a consumer destination associated with the consumer device, and iv) determine if the requested content fingerprint list is stored in the local storage device;
wherein the message processing controller is configured, if the content fingerprint list is not stored locally, to i) annotate the content name added to the pending interest table with a list annotation and ii) control the message routing module and source communication module to forward the content list interest message toward one or more potential sources of the content fingerprint list via the communication network.

17. The apparatus of claim 14 wherein the source communication module is configured to receive a fingerprint list message from a source device via the communication network, wherein the fingerprint list message identifies select content using a content name and includes a content fingerprint list with fingerprint names representing data chunks of the select content;
wherein the message processing controller is configured to i) receive the fingerprint list message from the source communication module, ii) store the content fingerprint list in the local storage device, iii) remove a list annotation from a content name stored in a pending interest table in the local storage device, wherein the content name identifies the select content media, and iv) determine if the content name in the pending interest table is annotated with an object annotation;
wherein the message processing controller is configured, if the content name is not annotated with the object annotation, to i) control the message routing module and consumer communication module to forward the fingerprint list message to a consumer destination associated with the content name in the pending interest table and ii) remove the content name from the pending interest table.

18. The apparatus of claim 14 wherein the consumer communication module is configured to receive a fingerprint interest message from a consumer device via the communication network, wherein the fingerprint interest message requests a fingerprint object message using a fingerprint name that represents a data chunk of content data for a portion of desired content;
wherein the message processing controller is configured to i) add the fingerprint name from the fingerprint interest message to a pending interest table in the local storage device, ii) annotate the fingerprint name added to the pending interest table with a consumer destination associated with the consumer device, and iii) determine if the fingerprint name is stored in a fingerprint index in the local storage device;
wherein the message processing controller is configured, if the fingerprint name is stored in the fingerprint index, to i) control the object caching module, message routing module, and consumer communication module to send the fingerprint object message associated with the fingerprint name from a local content store in the local storage device to the consumer destination associated with the fingerprint name in the pending interest table and ii) remove the fingerprint name from the pending interest table.

19. The apparatus of claim 14 wherein the source communication module is configured to receive a fingerprint object message from a source device via the communication network, wherein the fingerprint object message includes a fingerprint name and a data chunk such that the fingerprint name represents the data chunk which represents content data for a portion of select content;
wherein the message processing controller is configured to i) control the object caching module to store the fingerprint object message in a local content store in the local storage device, ii) control the object caching module to add the fingerprint name to a fingerprint index in the local storage device, and iii) determine if the fingerprint name is stored in a pending interest table in the local storage device;
wherein the message processing controller is configured, if the fingerprint name is stored in the pending interest table, to i) control the message routing module and consumer communication module to forward the fingerprint object message to a consumer destination associated with the fingerprint name in the pending interest table and ii) remove the fingerprint name from the pending interest table.

20. A non-transitory computer-readable medium storing program instructions that, when executed by a computer, cause a corresponding computer-controlled content- centric networking message processing subsystem in a network device within a communication network to perform a method for reducing content redundancy in content-centric networking, the method comprising:
processing a content object interest message in response to receiving the content object interest message from an originating consumer via a communication interface, wherein the content object interest message requests first desired content and identifies the first desired content using a first content name;
processing a content list interest message in response to receiving the content list interest message from a first consumer device via a communication network, wherein the content list interest message identifies second desired content using a second content name and requests a first content fingerprint list that identifies data chunks for the second desired content using fingerprint names;
processing a fingerprint list message in response to receiving the fingerprint list message from a first source device via the communication network, wherein the fingerprint list message identifies first select content using a third content name and includes a second content fingerprint list with fingerprint names representing data chunks of the first select content;
processing a fingerprint interest message in response to receiving the fingerprint interest message from a second consumer device via the communication network, wherein the fingerprint interest message requests a desired fingerprint object message using a first fingerprint name that represents a first data chunk of content data for a portion of third desired content; and
processing a fingerprint object message in response to receiving the fingerprint object message from a second source device via the communication network, wherein the fingerprint object message includes a second fingerprint name and a second data chunk such that the second fingerprint name represents the second data chunk which represents content data for a portion of second select content.
